(19) United States
(12) Patent Application Publication
(10) Pub. No.: US 2017/0330533 A1
(43) Pub. Date: Nov. 16, 2017

(54) METHOD FOR IMAGE DISPLAYING AND ELECTRONIC DEVICE THEREOF

(71) Applicant: MediaTek Singapore Pte. Ltd., Singapore (SG)

(72) Inventors: Xiang XU, Beijing City (CN); We LI, Beijing City (CN); Xiaobin WEI, Beijing City (CN); Kai ZHANG, Beijing City (CN)

(21) Appl. No.: 15/299,998

(22) Filed: Oct. 21, 2016

(30) Foreign Application Priority Data
May 10, 2016 (CN) 201610305885.5

(51) Int. Cl. G09G 5/391; G09G 5/38; G06F 3/0346; G09G 3/34

(52) U.S. Cl. CPC G09G 5/391; G09G 5/38; G09G 2340/045; G09G 2340/0407; G06F 3/0346; G09G 3/3406; G09G 2340/0492; G09G 2330/021

(57) ABSTRACT

A method for image displaying and an associated electronic device are provided. The method for image displaying includes the following steps: obtaining resolution adjusting information; reducing the current resolution to a first resolution in the resolution adjusting information; drawing an image according to the first resolution; displaying the image drawn in the first resolution on the screen.

### CROSS REFERENCE TO RELATED APPLICATIONS

This Application claims priority of China Patent Application No. 201610305885.5, filed on May 10, 2016, the entirety of which is incorporated by reference herein.

### BACKGROUND OF THE INVENTION

### Field of the Invention

The invention generally relates to image display technology, and more particularly, to a method for image displaying and an electronic device thereof.

### Description of the Related Art

Currently, electronic devices with a bigger display screen as the user interface have become more and more popular. The electronic devices may be common commercially available user devices, such as mobile phones, tablets, wearable devices, notebook computers and so on. Take a mobile phone as an example, as mobile phones continue to increase their resolution and screen size, power consumed by screen display becomes the main source of power consumption for the mobile phones. In addition, the resolution of current mobile phones is determined when the current mobile phones are switched-on. When displaying images, the mobile phone display is based on the resolution on lock.

During implementing the present invention, the inventors have found that the prior art at least has the following problems:

In currently existing technologies, mobile phones are unable to dynamically adjust resolutions. As a result, the screen tends to display images with the locked resolution, thereby leading to reduced battery life of the mobile phone.

### BRIEF SUMMARY OF THE INVENTION

Accordingly, embodiments of the invention provide a method for image displaying and an electronic device thereof to solve the problem of the prior art that the resolution being locked is unable to dynamically adjust so that the screen tends to display images with the locked resolution, thereby resulting in reduced battery life of the mobile phone.

To achieve the above object of the invention, in accordance with one aspect of the present invention, an embodiment of the present invention provides a method for image displaying, the method comprising:

obtaining resolution adjusting information;

reducing the current resolution to a first resolution in the resolution adjusting information;

drawing an image according to the first resolution; and

displaying the image drawn in the first resolution on a screen.

According to the aspects described above and any possible implementations, a further implementation is provided, wherein the step of obtaining the resolution adjusting information further comprises:

determining whether current power capacity of the electronic device is lower than a first threshold value; if the current power capacity of the electronic device is lower than the first threshold value, sending a resolution adjusting request to a user; obtaining the resolution adjusting information manually set by the user according to the resolution adjusting request; or

determining whether the current power capacity of the electronic device is lower than a second threshold value; if the current power capacity of the electronic device is lower than the second threshold value, sending the resolution adjusting request to the user, upon obtaining approved information about resolution adjustment from the user, obtaining the resolution adjusting information based on preset resolution adjusting rules; or

determining whether the current power capacity of the electronic device is lower than a third threshold value; if the current power capacity of the electronic device is lower than the third threshold value, automatically obtaining the resolution adjusting information based on the preset resolution adjusting rules; or

determining whether currently operated application of the electronic device is a default application, and if the currently operated application is the default application, obtaining the resolution adjusting information based on the preset resolution adjusting rules; or

obtaining the resolution adjusting request of the user; and obtaining the resolution adjusting information in the resolution adjusting request;

wherein the first threshold value, the second threshold value and the third threshold value are the same or different.

According to the aspects described above and any possible implementations, a further implementation is provided, wherein the resolution adjusting rules include a correspondence between the remaining power capacity and the resolution, a correspondence between the application and the resolution or a correspondence between user-input information and the resolution.

According to the aspects described above and any possible implementations, a further implementation is provided, wherein the aforementioned correspondences are stored in a memory of the electronic device.

According to the aspects described above and any possible implementations, a further implementation is provided, wherein before the step of displaying the image drawn in the first resolution on the screen, the method further comprises:

disabling the screen; and

performing re-initialization of the screen;

wherein the screen is a hot-pluggable screen.

According to the aspects described above and any possible implementations, a further implementation is provided, wherein after the step of obtaining the resolution adjusting information, the method further comprises:

sending a black image drawn to the screen, such that the screen uses the black image as a first frame image to be displayed on the screen;

determining a display area of the screen according to the first resolution;

wherein the step of drawing the image according to the first resolution further comprises:

drawing second frame images other than the first frame image based on the first resolution to enable the screen to display the second frame images drawn on the display area.

According to the aspects described above and any possible implementations, a further implementation is provided, wherein after the step of obtaining the resolution adjusting information, the method further comprises:

determining a display area of the screen according to the first resolution; and

turning off backlight display of display areas outside the display area.

According to the aspects described above and any possible implementations, a further implementation is provided, wherein the display area is partial area of the screen.

According to the aspects described above and any possible implementations, a further implementation is provided, wherein during the screen is displaying the second frame images drawn on the display area, the method further comprises:

detecting whether the screen is displayed in a landscape display or a portrait display:

when the screen is displayed in the portrait display, detecting current handheld status of the user, wherein the handheld statuses include a left handheld status and a right handheld status;

when detecting that the current handheld status of the user is the left handheld status, displaying the second frame images drawn on the display area in the lower left side of the screen;

when detecting that the current handheld status of the user is the right handheld status, displaying the second frame images drawn on the display area in the lower right side of the screen; and

when the screen is displayed in the landscape display, displaying the second frame images drawn on the display area predetermined of the screen.

According to the aspects described above and any possible implementations, a further implementation is provided, wherein during displaying the image drawn in the first resolution on the screen, the method further comprises:

enlarging the drawn image to a first image having the same size as the screen; and

displaying the enlarged first image on the screen.

In the embodiment of the present invention, by reducing the current resolution and drawing the images with the reduced resolution in order to ensure the screen displays images based on the reduced resolution, thereby achieving the purpose of power saving and increasing the life time of the electronic device.

To achieve the object of the invention, in accordance with another aspect of the present invention, an embodiment of the present invention provides an electronic device for image displaying, the electronic device comprising:

an obtaining module, configured to obtain resolution adjusting information;

an adjusting module, configured to reduce the current resolution to a first resolution in the resolution adjusting information;

a drawing module, configured to draw an image according to the first resolution; and

a display module, configured to display the image drawn in the first resolution on a screen.

According to the aspects described above and any possible implementations, a further implementation is provided, wherein the obtaining module is further configured to:

determine whether current power capacity of the electronic device is lower than a first threshold value; if the current power capacity of the electronic device is lower than the first threshold value, send a resolution adjusting request to a user; obtain the resolution adjusting information manually set by the user according to the resolution adjusting request; or

determine whether the current power capacity of the electronic device is lower than a second threshold value; if the current power capacity of the electronic device is lower than the second threshold value, send the resolution adjusting request to the user, upon obtaining approved information about resolution adjustment from the user, obtain the resolution adjusting information based on preset resolution adjusting rules; or

determine whether the current power capacity of the electronic device is lower than a third threshold value; if the current power capacity of the electronic device is lower than the third threshold value, automatically obtain the resolution adjusting information based on the preset resolution adjusting rules; or

determine whether currently operated application of the electronic device is a default application, and if the currently operated application is the default application, obtain the resolution adjusting information based on the preset resolution adjusting rules; or

obtain the resolution adjusting request of the user; and obtain the resolution adjusting information in the resolution adjusting request;

wherein the first threshold value, the second threshold value and the third threshold value are the same or different.

According to the aspects described above and any possible implementations, a further implementation is provided, wherein the resolution adjusting rules include a correspondence between the remaining power capacity and the resolution, a correspondence between the application and the resolution or a correspondence between user-input information and the resolution.

According to the aspects described above and any possible implementations, a further implementation is provided, wherein the aforementioned correspondences are stored in a memory of the electronic device

According to the aspects described above and any possible implementations, a further implementation is provided, wherein the electronic device further comprising:

a disabling module, configured to disable the screen before the displaying of the image drawn by the drawing module on the screen; and

an initialization module, configured to perform re-initialization of the screen;

wherein the screen is a hot-pluggable screen.

According to the aspects described above and any possible implementations, a further implementation is provided, wherein the electronic device further comprising:

a sending module, configured to send a black image drawn by the drawing module to the screen after the resolution adjusting information is obtained by the obtaining module, such that the display module uses the black image as a first frame image to be displayed on the screen;

a first determination module, configured to determine a display area of the screen according to the first resolution;

wherein the drawing module is further configured to:

draw second frame images other than the first frame image based on the first resolution, such that the display module displays the second frame images drawn on the display area.

According to the aspects described above and any possible implementations, a further implementation is provided, wherein the electronic device further comprising:

a second determination module, configured to determine a display area of the screen according to the first resolution after the resolution adjusting information is obtained by the obtaining module; and

a turning-off module, configured to turn off backlight display of display areas outside the display area.

According to the aspects described above and any possible implementations, a further implementation is provided, wherein the display area is partial area of the screen.

According to the aspects described above and any possible implementations, a further implementation is provided, wherein the electronic device further comprising:

a detection module, configured to detect whether the screen is displayed in a landscape display or a portrait display during the display module is displaying the second frame images drawn on the display area;

and the detection module is further configured to:

when the screen is displayed in the portrait display, detect current handheld status of the user, wherein the handheld statuses include a left handheld status and a right handheld status;

the display module, when the current handheld status of the user being the left handheld status is detected, is further configured to display the second frame images drawn on the display area in the lower left side of the screen;

the display module, when the current handheld status of the user being the right handheld status is detected, is further configured to display the second frame images drawn on the display area in the lower right side of the screen; and

the display module, when the screen is displayed in the landscape display, is further configured to display the second frame images drawn on the display area predetermined of the screen.

According to the aspects described above and any possible implementations, a further implementation is provided, wherein the display module is further configured to:

enlarge the drawn image to a first image having the same size as the screen during the display module is displaying the image drawn in the first resolution on the screen; and

display the enlarged first image on the screen.

In the embodiment of the present invention, the adjusting module is used to reduce the current resolution, while the drawing module draws images with the reduced resolution in order to ensure the display module displays the images based on the reduced resolution, thereby achieving the purpose of power saving and increasing the life time of the device.

### BRIEF DESCRIPTION OF DRAWINGS

The invention can be more fully understood by reading the subsequent detailed description and examples with references made to the accompanying drawings, wherein:

FIG. 1 is a flow chart of a method for image displaying according to an embodiment of the invention;

FIG. 2 is a schematic diagram illustrating a display effect of an image displayed in the lower left side of the screen according to an embodiment of the invention;

FIG. 3 is a schematic diagram illustrating a display effect of an enlarged first image displayed in the screen according to an embodiment of the invention;

FIG. 4 is a schematic diagram illustrating a frame structure of a system according to an embodiment of the invention; and

FIG. 5 is a schematic diagram illustrating a structure of an electronic device for image displaying according to an embodiment of the invention.

### DETAILED DESCRIPTION OF THE INVENTION

The invention can be more fully understood by reading the subsequent detailed description and examples with references made to the accompanying drawings.

It should be clear that the described embodiments are merely part of the embodiments of the present invention, but not all embodiments. Based on the embodiments of the present invention, those who skilled in this art in not making all other embodiments without creative efforts obtained, are within the scope of the present invention is protected.

Terminology used in the example embodiment of the present invention is merely for the purpose of describing particular embodiments only and not intended to limit the present invention. In the embodiments and the appended claims, the singular forms of the present invention that uses the word “a”, “an”, “said” and “the” are intended to include most forms unless the context clearly dictates otherwise.

Depending on the context of the disclosure, as used herein, the word “if” can be interpreted as “during . . . ” or “when . . . ” or “in response to determining” or “in response to detection.” Similarly, depending on the context of the disclosure, the phrase “if it is determined” or “if it is detected (stated condition or event)” may be interpreted as “when determining” or “in response to determining” or “When it is detected (stated condition or event) “or” in response to detecting (stated condition or event).”

### First Embodiment

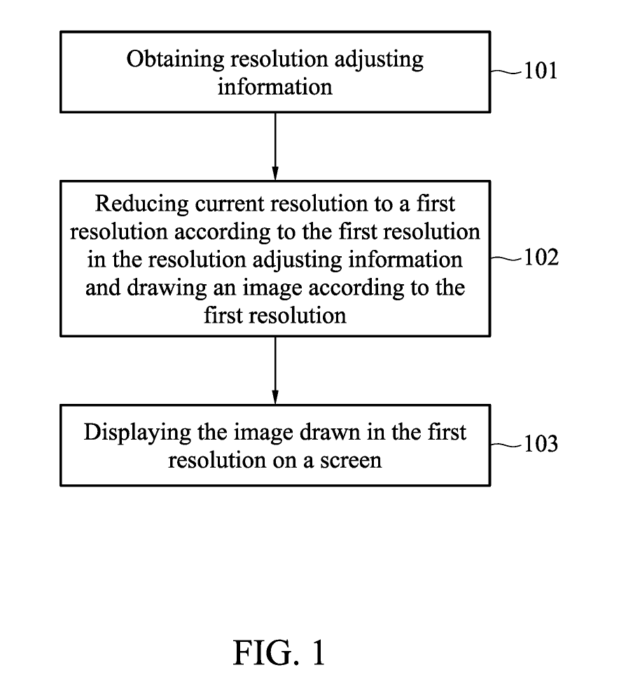

In order to solve the problem of the prior art that the resolution being locked is unable to dynamically adjust so that the screen tends to display images with the locked resolution, thereby resulting in reduced battery life of the mobile phone, an embodiment of the present invention provides a method for image displaying. Specifically, FIG. 1 is a flow chart of a method for image displaying according to the embodiment of the invention. The method may include the following steps:

Step 101: resolution adjusting information is obtained.

It should be noted that the electronic device of the embodiment of the invention may include, but is not limited to, Personal Computer (PC), a Personal Digital Assistant (PDA), wireless handheld device, Tablet Computer, mobile phone, MP4 player or other electronic device capable of displaying image on the screen.

Obtaining resolution adjusting information can be divided into actively obtaining resolution adjusting information and passively obtaining resolution adjusting information. Specifically, the steps of obtaining the resolution adjusting information may further comprise:

determining whether current power capacity of the electronic device is lower than a first threshold value; if the current power capacity of the electronic device is lower than the first threshold value, sending a resolution adjusting request to a user; obtaining the resolution adjusting information manually set by the user according to the resolution adjusting request; or, determining whether the current power capacity of the electronic device is lower than a second threshold value; if the current power capacity of the electronic device is lower than the second threshold value, sending a resolution adjusting request to a user; upon obtaining approved information about resolution adjustment from the user, obtaining the resolution adjusting information based on preset resolution adjusting rules; or determining whether the current power capacity of the electronic device is lower than a third threshold value; if the current power capacity of the electronic device is lower than the third threshold value, automatically obtaining the resolution adjusting information based on the preset resolution adjusting rules; or determining whether currently operated application of the electronic device is a default application, and if the currently operated application is the default application, obtaining the resolution adjusting information based on the preset resolution adjusting rules; or obtaining the resolution adjusting request of the user; and obtaining the resolution adjusting information in the resolution adjusting request; wherein the first threshold, the second threshold and the third threshold value can be the same or different.

It should be noted that the threshold value can be set based on the user's own situation, or the device has been preset by the manufacturer. The specific setting method and the threshold value are determined depending on the circumstances. In addition, if the current power capacity is more than or equal to the threshold value, the currently operated application of the electronic device is not the default application or the resolution adjusting request of the user is not received, the resolution will not be adjusted.

Wherein, the resolution adjusting rules mentioned above may include but are not limited to the following:

1. A correspondence between the remaining power capacity and the resolution, in which corresponding resolution adjusting information can be obtained based on the correspondence and remaining power capacity. The abovementioned correspondence can be stored in a memory of the electronic device for a processor of the device use.

2. A correspondence between the application and resolution, in which corresponding resolution adjusting information can be obtained based on the correspondence and applications being currently operated. Similarly, the abovementioned correspondence can be stored in the memory of the electronic device for the processor of the device use.

3. A correspondence between user-input information (such as clicking information, sliding information, shaking information, or gesture, etc.) and the resolution, in which the corresponding resolution adjusting information can be obtained based on the correspondence and the user-input information (such as the shaking information, the gesture or the like). Similarly, the abovementioned correspondence can be stored in the memory of the electronic device for the processor of the device use.

The purpose of the embodiments of the invention is to obtain the resolution adjusting information based on the set correspondences, and thus all correspondences capable of obtaining the resolution adjusting information are within the scope of the present invention. The correspondence of the embodiment of the present invention can be set based on the user's own situation, or the device has been preset by the manufacturer. Specific correspondence settings are determined depending on the circumstances. For example, when the remaining power capacity is more than 60%, the corresponding resolution is 1080P; when the remaining power capacity is between 40% and 60%, the corresponding resolution is 720P and so on. For another example, the resolution is 1080P when an application is a video type application, while the resolution is 720P when an application is an instant message communication application and so on. It should be understood that, above description describes some of the specific correspondences, of course, there may also include other correspondences, and detailed are omitted here for brevity.

Step 102, according to a first resolution carried by the resolution adjusting information, the current resolution is reduced to the first resolution to draw the image based on the first resolution.

Specifically, as the current resolution can be reduced, when drawing an image, the quantity of pixels drawn decreases, thereby achieving the goal of power saving. In addition, as the display layer of the electronic device contains multiple layers, when drawing the image in every layer, the drawing is based on a set resolution. Therefore, when the current resolution is reduced, the quantity of pixels drawn reduces for every image layer drawn, which further saves power.

Step 103, the image drawn is displayed on the screen.

Specifically, after the electronic device completes drawing of an image, the image needs to be displayed on the screen. Since the quantity of pixels drawn decreases when the image is drawn, the image displayed on the screen based on the drawn image becomes smaller, thus decreasing the number of pixels to be changed and further achieving a goal for power saving.

Before displaying the image drawn in the first resolution on the screen, the method for image displaying may further comprise:

disabling the screen; and performing re-initialization of the screen; wherein the screen is a hot-pluggable screen.

Specifically, since the entire process of displaying an image drawn after reducing its resolution following the display of a normal resolution image is quite complex, in order to avoid the adverse effects of complex operations on both the electronic equipment and the user and to prevent problems arising from complex operations, screen disabling (i.e. disconnect the screen power) and screen re-initialization (i.e. screen power up) should be performed to prevent the effects arising from complex operations. Additionally, when the screen is a hot-pluggable screen, the abovementioned screen power cutoff and power-up operation can be easier controlled.

After obtaining the resolution adjusting information, the method for image displaying may further comprise:

sending a black image drawn to the screen, such that the screen uses the black image as a first frame image to be displayed on the screen; determining a display area of the screen according to the first resolution (such as the partial area of the screen). In particular, the display region is the partial area of the screen.

The step of drawing the image according to the first resolution may further comprise:

drawing second frame images which are frame images other than the first frame image based on the first resolution to enable the screen to display the second frame images drawn on the display area. In particular, the display region is the partial area of the screen.

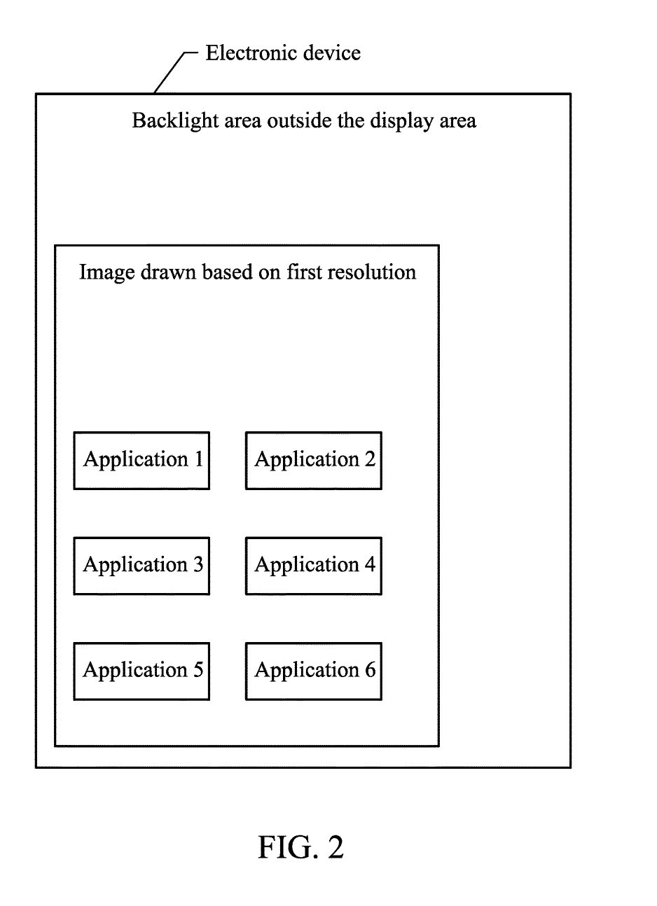

Specifically, since the twist angles of various pixels on the screen after screen disabling and re-initialization may vary, different colors may appear. This causes the screen color to be uneven, further leading to the spark plate phenomenon. In order to prevent such a phenomenon, the black image drawn on the screen according to the original resolution will unify the twisted angles of the pixels. When the screen displays other images drawn in the display area, only the display area will show the images, while the other areas will remain black. Since black is a relatively more power saving color compared to other colors, the purpose of power saving can be further achieved. The image display area's length-width ratio is the same as that of the device screen. In particular, the effect diagram of the above method for image displaying is specifically shown in FIG. 2.

Similarly, in order to achieve the goal of power saving, after obtaining the resolution adjusting information, the method for image displaying may further comprise:

determining a display area of the screen (such as the partial area of the display screen) according to the first resolution; and turning off the backlight display outside the display area.

In particular, the display area is the partial area of the screen.

Specifically, for a screen with self-luminous pixels, since each pixel is self-luminous, independent control of respective pixels on the screen can be performed. The backlight of the areas not displaying the image can be turned off. This way, no power is required for the areas not displaying the image, thereby achieving the goal of power saving. In particular, the effect diagram of the above method for image displaying is specifically shown in FIG. 2.

Furthermore, since the screen displays images in a partial area of the screen, in order to make it convenient for users to operate, during the screen is displaying the drawn other frame images on the display area, the method for image displaying may further comprise:

detecting whether the screen is displayed in a landscape display or portrait display: when the screen is displayed in the portrait display, detecting current handheld status of the user, wherein the handheld statuses include a left handheld status and a right handheld status; when detecting that the current handheld status of the user is the left handheld status, the screen displaying other frame images drawn on the display area in the lower left side of the screen; when detecting that the current handheld status of the user is the right handheld status, the screen displaying other frame images drawn on the display area in the lower right side of the screen; and when the screen is displayed in the landscape display, displaying other frame images drawn on the display area predetermined of the screen.

Specifically, as the handheld methods for the electronic device being operated in the landscape status and that for the electronic device being operated in the portrait status are different, the operation method also differs. It is therefore necessary to first determine whether the electronic device is in the landscape status or the portrait status. The width and height size of an image displayed on the screen can be used to determine whether the electronic device is in a landscape display or a portrait display. When the width of the image is more than its height, the electronic device determine that it is to be the landscape display; when the width of the image is less than its height, the electronic device determine that it is to be the landscape display. It can also be determined through a gyroscope, as it can accurately acquire the electronic device's rotation and deflection. The gyroscope, through the device rotation and deflection measurement, can determine whether the device is in the landscape or portrait status. Of course, a gravity sensor can also be used to determine the status. When a gravity block changes the direction due to gravity, the piezoelectric crystal below the gravity block receives a change in resistance, which is used to determine the direction of gravity. Based on the direction of gravity, whether the device is in landscape or portrait status can be determined.

In portrait display, the user can hold the electronic device with their left hand or right hand. Under different handheld statuses, during single-handed operation the user tends to touch a different area. For example, when the user's current handheld status is a left handheld status, the user can flexibly use the left thumb to touch the lower left side of the device screen; when the user's current handheld status is a right handheld status, the user can flexibly use the right thumb to touch the lower right side of the device screen. Therefore, it is required to detect whether the user's current handheld status is the left handheld status or the right handheld status. Of course, when drawing other images, they can also be drawn on the upper left, upper right, or the middle area of the left and right of the screen. The location of drawing for other images can be determined based on the actual situation.

In particular, when detecting the user's current handheld status, the number of fingers on both sides of the left and right edges can be the basis for determining the user's current handheld status. In summary, the above embodiments are examples for determining the user's current handheld statuses, other methods for determining the user's current handheld status are all within the scope of the present invention.

When the screen display is in landscape status, the user's handheld device status is rather special. The user can hold the device with both hands. At this time, the image needs to be displayed in the preset display area, in which the preset display area can be set based on user's own habits, or it can also be set under other circumstances. Specific circumstances can be determined based on the actual situation.

During displaying the image drawn in the first resolution on the screen, the method for image displaying may further comprise:

enlarging the drawn image to a first image having the same size as the screen; and displaying the enlarged first image on the screen.

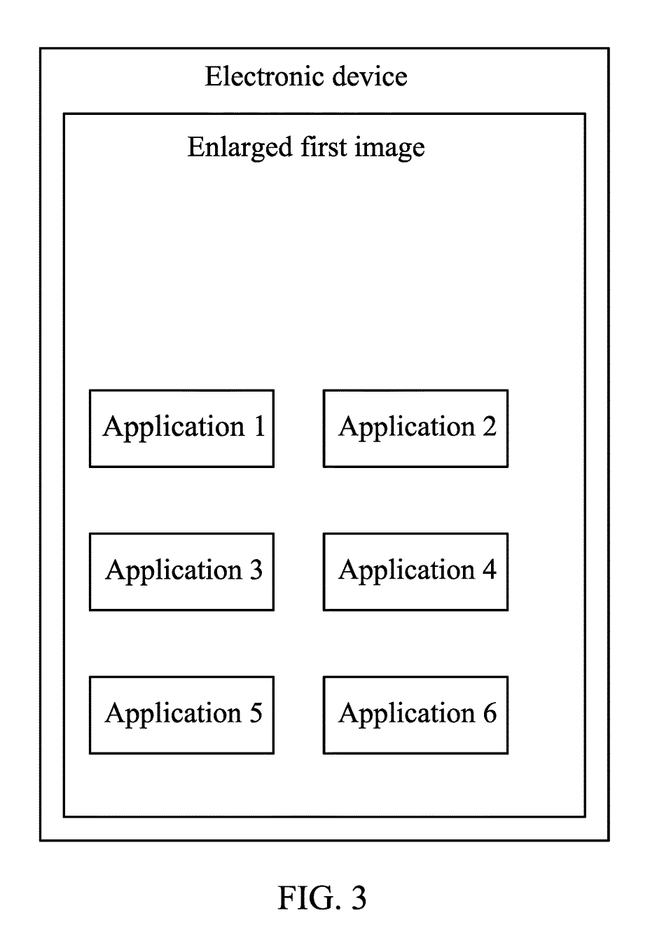

Specifically, the image drawn based on the adjusted resolution is enlarged on the screen based on the screen size for full-screen display. Based on the user's daily operating habits, the device is operated for drawing at a reduced resolution. Before display, the image is enlarged again. The image clarity may be slightly reduced, but the image drawing process is power saving. If the image is enlarged after overlaying, the image reading and overlaying process will also be power saving. In particular, the effect diagram of the above method for image displaying is specifically shown in FIG. 3.

In the embodiment of the present invention, the electronic device comprises an adjusting module, a drawing module and a display module. Wherein, the adjusting module is used to reduce the current resolution, while the drawing module draws images based on the reduced resolution in order to ensure that the display module displays images based on the reduced resolution, thereby achieving the purpose of power saving and increasing the life time of the electronic device.

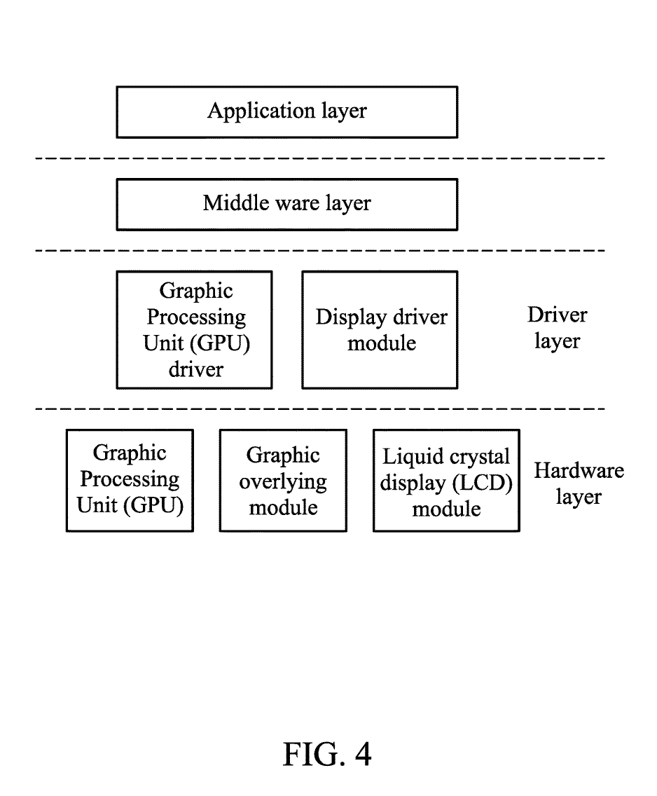

In order to further illustrate the idea of the present invention, specific application scenarios are combined to more clearly describe the technical aspect of the present invention. Specifically, FIG. 4 is a schematic diagram illustrating a frame structure of a system according to an embodiment of the invention, wherein the liquid crystal display module (LCD Module, abbreviated LCM) is a hot pluggable liquid crystal display module, the system includes a driver layer, a middle ware layer, a hardware layer and an application layer (abbreviated APP layer). The system for method for image displaying is as follows:

1. After the display driver module of the driver layer obtains the resolution adjusting information, the display driver module reduces the current resolution according to the resolution adjusting information, and sends the reduced resolution to the APP via the middle ware layer.

2. The APP sends to the image to be displayed and the corresponding resolution to the middle ware layer.

3. The middle ware layer calls the image, and then sends the image and the corresponding resolution to the Graphic Processing Unit (GPU) driver of the driver layer to enable the GPU driver to draw the image on a certain number of pixels based on the image and the corresponding resolution. Drawing the image may further need to draw the image with a certain number of pixels on different display layers according to the number of display layers for the electronic device.

4. After the GPU completes the drawing of the image, the GPU driver sends the image to the display driver to enable the display driver to overly images of different layers and then drive the LCM to display the image on the image display area.

5. After the display driver obtains the resolution adjusting information, the display driver disconnects the LCM, initializes the LCM and sends a pre-stored black image to be displayed by the LCM or turns off the pixels within the areas that do not display the image.

Wherein, when the LCM is displaying an image on the area for displaying the image, the areas that do not display the image are still displayed with black pixels or the backlight display of which are being turned off.

In the entire process described above, since the pixels on the various display layers drawn using the GPU are decreased, at the time of image overlay and LCM display, the overlaying and display are based on the reduced resolution. At the time of the LCM image display, a part of the area shows a black image, or the backlight is turned off, thus greatly saving power.

When the LCM displays an image in the image display area, the displayed image can be enlarged to the size of the screen for display. However, during the process before an image display, both image drawing and image overlaying are based on the reduced resolution. Therefore, under the premise that the user's operating habit remains unchanged, the purpose of power saving can be achieved.

When LCM image displayed on the display area of the image, you can also enlarge the image displayed image to the screen size of the display, but the display image before the process, whether it is to draw the image or images are superimposed in order of decreasing after the resolution was thus achieved without changing user habits prerequisite to achieve the purpose of saving.

### Second Embodiment

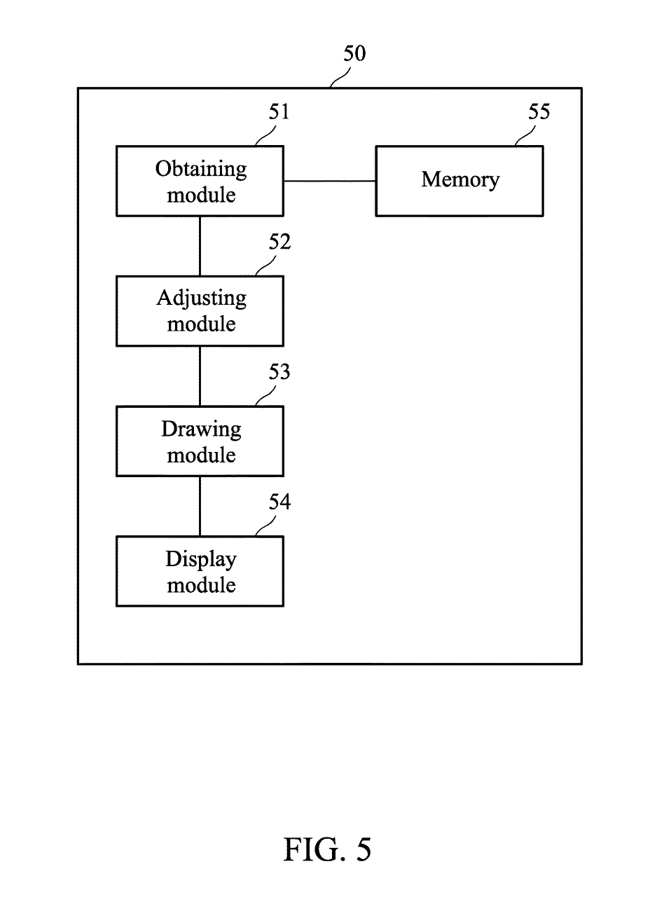

Further embodiments of electronic devices of the invention are given to achieve aforementioned methods and steps in the above embodiments. As shown in FIG. 5, which is a schematic diagram illustrating functional blocks of an electronic device 50 according to an embodiment of the invention. The electronic device 50 may include:

an obtaining module 51, which is configured to obtain resolution adjusting information;

an adjusting module 52, which is configured to reduce the current resolution to a first resolution according to the first resolution in the resolution adjusting information;

a drawing module 53, which is configured to draw an image according to the first resolution; and

a display module 54, which is configured to display the image drawn in the first resolution on a screen.

Specifically, the obtaining module is further configured to: determine whether current power capacity of the electronic device 50 is lower than a first threshold value; if the current power capacity of the electronic device 50 is lower than the first threshold value, send a resolution adjusting request to a user; obtain the resolution adjusting request adjusting information manually set by the user according to the resolution adjusting request; or, determine whether the current power capacity of the electronic device 50 is lower than a second threshold value; if the current power capacity of the electronic device 50 is lower than the second threshold value, send a resolution adjusting request to a user; upon obtaining approved information about resolution adjustment from the user, obtain the resolution adjusting information based on preset resolution adjusting rules; or determine whether the current power capacity of the electronic device 50 is lower than a third threshold value; if the current power capacity of the electronic device 50 is lower than the third threshold value, automatically obtain the resolution adjusting information based on the preset resolution adjusting rules; or determine whether currently operated application of the electronic device 50 is a default application, and if the currently operated application is the default application, obtain the resolution adjusting information based on the preset resolution adjusting rules; or obtain the resolution adjusting request of the user; and obtain the resolution adjusting information in the resolution adjusting request; wherein the first threshold, the second threshold and the third threshold value are the same or different.

The resolution adjusting rules may include a correspondence between the remaining power capacity and the resolution, a correspondence between the application and the resolution or a correspondence between user-input information and the resolution.

The electronic device may further comprise:

a disabling module, which is configured to disable the screen before the displaying of the image drawn by the drawing module on the screen; and

an initialization module, which is configured to perform re-initialization of the screen,

wherein the screen is a hot-pluggable screen.

The electronic device may further comprise:

a sending module, which is configured to send a black image drawn by the drawing module to the screen after the resolution adjusting information is obtained by the obtaining module, the method, such that the display module uses the black image as a first frame image to be displayed on the screen; and

a first determination module, which is configured to determine a display area of the screen according to the first resolution.

The drawing module may further be configured to:

draw second frame images other than the first frame image based on the first resolution, such that the display module displays the second frame images drawn on the display area.

In another embodiment, the electronic device may further comprise:

a second determination module, which is configured to determine a display area of the screen according to the first resolution after the resolution adjusting information is obtained by the obtaining module; and

a turning-off module, which is configured to turn off the backlight display of display areas outside the display area.

The display area may be a partial area of the screen.

The electronic device may further comprise:

a detection module, which is configured to detect whether the screen is displayed in a landscape display or portrait display during the display module is displaying the second frame images drawn on the display area.

The detection module may further be configured to:

when the screen is displayed in the portrait display, detect current handheld status of the user, wherein the handheld statuses include a left handheld status and a right handheld status.

The display module, when the current handheld status of the user being the left handheld status is detected, is further configured to display the second frame images drawn on the display area in the lower left side of the screen.

The display module, when the current handheld status of the user being the right handheld status is detected, is further configured to display the second frame images drawn on the display area in the lower right side of the screen.

The display module, when the screen is displayed in the landscape display, is further configured to display the second frame images drawn on the display area predetermined of the screen.

The display module is further configured to:

enlarge the drawn image to a first image having the same size as the screen during the display module is displaying the image drawn in the first resolution on the screen; and

display the enlarged first image on the screen.

In the embodiment of the present invention, the adjusting module is used to reduce the current resolution, while the drawing module draws images based on the reduced resolution in order to ensure the display module displays images based on the reduced resolution, thereby achieving the purpose of power saving and increasing the life time of the electronic device.

Further, the electronic device disclosed in the present invention may further comprise a memory 55 for storing the resolution adjusting rules utilized by the adjusting module 52, i.e., the aforementioned correspondences included in the resolution adjusting rules are stored in the memory 55 of the electronic device 50.

Note that the adjusting module 52 may determine the reduced screen resolution, that is, the first resolution, based on the resolution adjusting rules.

It should be understood by those who are skilled in this technology that: all or part of the steps in the above-described methods of the embodiments may be implemented by a program instructions relevant hardware. The program may be stored in a computer readable storage medium. When the program is being executed, each of the steps in the above-described method embodiments can be performed; and the aforementioned storage medium may include: any medium capable of storing the program codes, such as ROM, RAM, disk, or an optical disk and so on.

The device embodiments as described above are merely illustrative in nature, wherein the unit described as a separate component may be or may not be physically separated, and components displayed as the unit may or may not be a physical unit, which can be located in one place, or be distributed to at least two network units. Part or all of the units may be selected to achieve the object of the embodiment according to the actual needs. Based on the embodiments of the present invention, those who are skilled in this technology in making all other embodiments with no creative effort obtained are within the scope of protection of the present invention.

Finally, it should be noted that: the above embodiments are merely made for the purpose of illustrating the general principles of the invention and should not be taken in a limiting sense. While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for image displaying in an electronic device, comprising:
obtaining resolution adjusting information;
reducing the current resolution to a first resolution in the resolution adjusting information;
drawing an image according to the first resolution; and
displaying the image drawn in the first resolution on a screen.

2. The method according to claim 1, wherein the step of obtaining the resolution adjusting information further comprises:
determining whether current power capacity of the electronic device is lower than a first threshold value; if the current power capacity of the electronic device is lower than the first threshold value, sending a resolution adjusting request to a user; obtaining the resolution adjusting information manually set by the user according to the resolution adjusting request; or
determining whether the current power capacity of the electronic device is lower than a second threshold value; if the current power capacity of the electronic device is lower than the second threshold value, sending the resolution adjusting request to the user, upon obtaining approved information about resolution adjustment from the user, obtaining the resolution adjusting information based on preset resolution adjusting rules; or
determining whether the current power capacity of the electronic device is lower than a third threshold value; if the current power capacity of the electronic device is lower than the third threshold value, automatically obtaining the resolution adjusting information based on the preset resolution adjusting rules; or
determining whether currently operated application of the electronic device is a default application, and if the currently operated application is the default application, obtaining the resolution adjusting information based on the preset resolution adjusting rules; or
obtaining the resolution adjusting request of the user; and obtaining the resolution adjusting information in the resolution adjusting request;
wherein the first threshold value, the second threshold value and the third threshold value are the same or different.

3. The method according to claim 2, wherein the resolution adjusting rules include a correspondence between the remaining power capacity and the resolution, a correspondence between the application and the resolution or a correspondence between user-input information and the resolution.

4. The method according to claim 3, wherein the correspondences are stored in a memory of the electronic device.

5. The method according to claim 1, wherein before the step of displaying the image drawn in the first resolution on the screen, the method further comprises:
disabling the screen; and
performing re-initialization of the screen;
wherein the screen is a hot-pluggable screen.

6. The method according to claim 5, wherein after the step of obtaining the resolution adjusting information, the method further comprises:
sending a black image drawn to the screen, such that the screen uses the black image as a first frame image to be displayed on the screen;
determining a display area of the screen according to the first resolution;
wherein the step of drawing the image according to the first resolution further comprises:
drawing second frame images other than the first frame image based on the first resolution to enable the screen to display the second frame images drawn on the display area.

7. The method according to claim 1, wherein after the step of obtaining the resolution adjusting information, the method further comprises:
determining a display area of the screen according to the first resolution; and
turning off backlight display of display areas outside the display area.

8. The method according to claim 7, wherein the display area is partial area of the screen.

9. The method according to claim 6, wherein during the screen is displaying the second frame images drawn on the display area, the method further comprises:
detecting whether the screen is displayed in a landscape display or a portrait display:
when the screen is displayed in the portrait display, detecting current handheld status of the user, wherein the handheld statuses include a left handheld status and a right handheld status;
when detecting that the current handheld status of the user is the left handheld status, displaying the second frame images drawn on the display area in the lower left side of the screen;
when detecting that the current handheld status of the user is the right handheld status, displaying the second frame images drawn on the display area in the lower right side of the screen; and
when the screen is displayed in the landscape display, displaying the second frame images drawn on the display area predetermined of the screen.

10. The method according to claim 1, wherein, during displaying the image drawn in the first resolution on the screen, the method further comprises:
enlarging the drawn image to a first image having the same size as the screen; and
displaying the enlarged first image on the screen.

11. An electronic device for image displaying, comprising:
an obtaining module, configured to obtain resolution adjusting information;
an adjusting module, configured to reduce the current resolution to a first resolution in the resolution adjusting information;
a drawing module, configured to draw an image according to the first resolution; and
a display module, configured to display the image drawn in the first resolution on a screen.

12. The electronic device according to claim 11, wherein the obtaining module is further configured to:
determine whether current power capacity of the electronic device is lower than a first threshold value; if the current power capacity of the electronic device is lower than the first threshold value, send a resolution adjusting request to a user; obtain the resolution adjusting information manually set by the user according to the resolution adjusting request; or
determine whether the current power capacity of the electronic device is lower than a second threshold value; if the current power capacity of the electronic device is lower than the second threshold value, sending the resolution adjusting request to the user, upon obtaining approved information about resolution adjustment from the user, obtain the resolution adjusting information based on preset resolution adjusting rules; or
determine whether the current power capacity of the electronic device is lower than a third threshold value; if the current power capacity of the electronic device is lower than the third threshold value, automatically obtain the resolution adjusting information based on the preset resolution adjusting rules; or
determine whether currently operated application of the electronic device is a default application, and if the currently operated application is the default application, obtain the resolution adjusting information based on the preset resolution adjusting rules; or
obtain the resolution adjusting request of the user; and obtain the resolution adjusting information in the resolution adjusting request;
wherein the first threshold value, the second threshold value and the third threshold value are the same or different.

13. The electronic device according to claim 12, wherein the resolution adjusting rules include a correspondence between the remaining power capacity and the resolution, a correspondence between the application and the resolution or a correspondence between user-input information and the resolution.

14. The electronic device according to claim 13, wherein the correspondences are stored in a memory of the electronic device.

15. The electronic device according to claim 11, further comprising:
a disabling module, configured to disable the screen before the displaying of the image drawn by the drawing module on the screen; and
an initialization module, configured to perform re-initialization of the screen;
wherein the screen is a hot-pluggable screen.

16. The electronic device according to claim 15, further comprising:
a sending module, configured to send a black image drawn by the drawing module to the screen after the resolution adjusting information is obtained by the obtaining module, such that the display module uses the black image as a first frame image to be displayed on the screen;
a first determination module, configured to determine a display area of the screen according to the first resolution;
wherein the drawing module is further configured to:
draw second frame images other than the first frame image based on the first resolution, such that the display module displays the second frame images drawn on the display area.

17. The electronic device according to claim 11, further comprising:
a second determination module, configured to determine a display area of the screen according to the first resolution after the resolution adjusting information is obtained by the obtaining module; and
a turning-off module, configured to turn off backlight display of display areas outside the display area.

18. The electronic device according to claim 17, wherein the display area is partial area of the screen.

19. The electronic device according to claim 16, further comprising:
a detection module, configured to detect whether the screen is displayed in a landscape display or a portrait display during the display module is displaying the second frame images drawn on the display area;
and the detection module is further configured to:
when the screen is displayed in the portrait display, detect current handheld status of the user, wherein the handheld statuses include a left handheld status and a right handheld status;
the display module, when the current handheld status of the user being the left handheld status is detected, is further configured to display the second frame images drawn on the display area in the lower left side of the screen;
the display module, when the current handheld status of the user being the right handheld status is detected, is further configured to display the second frame images drawn on the display area in the lower right side of the screen; and
the display module, when the screen is displayed in the landscape display, is further configured to display the second frame images drawn on the display area predetermined of the screen.

20. The electronic device according to claim 11, wherein the display module is further configured to:
enlarge the drawn image to a first image having the same size as the screen during the display module is displaying the image drawn in the first resolution on the screen; and
display the enlarged first image on the screen.
